(19) United States
(12) Patent Application Publication
(10) Pub. No.: US 2013/0018920 A1
(43) Pub. Date: Jan. 17, 2013

(54) CONFIGURATION MANAGEMENT DATABASE SECURITY

(71) Applicant: Andrew M. Griffin, Fort Collins, CO (US)

(72) Inventor: Andrew M. Griffin, Fort Collins, CO (US)

(21) Appl. No.: 13/180,914

(22) Filed: Jul. 12, 2011

(51) Int. Cl. G06F 17/30

(52) U.S. Cl. 707/783; 707/E17.005

(57) ABSTRACT

Methods, systems, and computer-readable media with executable instructions stored thereon for Configuration Management Database security are provided. Resource data and user security policy data can be loaded from a number of different sources into the CMDB. The resource data and user security policy data can be tagged with an identity of a source of the resource data and an identity of a source of the user security policy data. A number of data filters can be added to the CMDB and at least one of the data filters can be used to filter a user query of the resource data.

### BACKGROUND

A configuration management database (CMDB) is a repository of information related to components of an information system. A CMDB can store a large amount of data. Users can access and utilize data within the CMDB. A CMDB can involve federation, the inclusion of data into the CMDB from other sources where each such source retains control of the data supplied to the CMDB.

### BRIEF DESCRIPTION OF THE DRAWINGS

FIG. 1 illustrates a flow chart of an example of a method for configuration management database security according to the present disclosure.

FIG. 2 illustrates a block diagram of an example of an extraction, transformation, load process according to the present disclosure.

FIG. 3 illustrates a block diagram of an example of a computer-readable medium in communication with processing resources for Configuration Management Database security according to the present disclosure.

### DETAILED DESCRIPTION

Examples of the present disclosure include methods, systems, and computer-readable media with executable instructions stored thereon for Configuration Management Database (CMDB) security. Resource data and user security policy data can be loaded from a number of different sources into the CMDB. The resource data and user security policy data can be tagged with an identity of a source of the resource data and an identity of a source of the user security policy data. A number of data filters can be added to the CMDB and at least one of the data filters can be used to filter a user query of the resource data.

CMDBs are used to store large amounts of data from different sources and allowing ready access to that data. Users can search (e.g., query) the data in the CMDB via access rules. Access rules are typically manually created for the CMDB and can be based on each source from which the data originated. Creating data access rules for each source represented in a CMDB is a time consuming and error prone process. CMDB source defined data access rules that can be implemented via a uniform process can, for example, reduce CMDB system complexity, data access rule entry errors, and/or time.

In the present disclosure, reference is made to the accompanying drawings that form a part hereof, and in which is shown by way of illustration how one or more examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

Elements shown in the various figures herein can be added, exchanged, and/or eliminated so as to provide a number of additional examples of the present disclosure. Figure elements that include an element number with the letter ‘N’ represent any number of additional elements. In addition, the proportion and the relative scale of the elements provided in the figures are intended to illustrate the examples of the present disclosure, and should not be taken in a limiting sense.

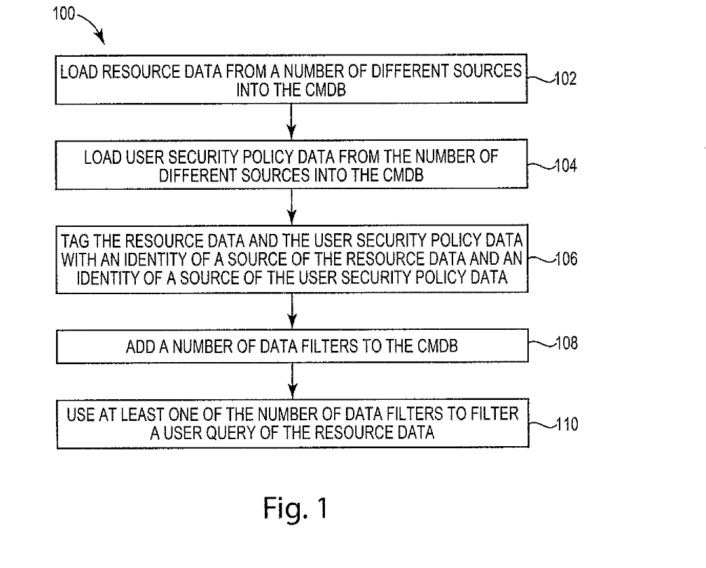

FIG. 1 illustrates a flow chart of a method 100 for configuration management database (CMDB) security according to the present disclosure. A CMDB is a repository of information related to components of an information system. In one or more example, a CMDB of the present disclosure uses an extract, transform, load (ETL) process that copies data into the CMDB. Resource data is loaded from a number of different sources into the CMDB, at 102. Resource data can be a number of data types. For example, resource data can include, but is not limited to, documents, videos, music, metadata, images, sound files, presentations, user credentials, and web pages, etc. Sources can include a number of different sources that contain data. In one or more examples of the present disclosure, a source has an operational system different than the CMDB. Examples of sources include, but are not limited to, a number of memory devices in an infrastructure connected to the CMDB, computer systems, disk drives, applications, information related to configuration items (Cis), and/or combinations thereof, etc.

At 104, user security policy data is loaded from the number of different sources into the CMDB. User security policy data can include data that is used to log a user into a system to access data. For example, security policy data can include, but is not limited to, login information of a user, a username, a user password, a passkey, onetime log-in credentials (e.g., number used once (nonce)), security questions, user credentials, and/or combinations thereof. In one or more examples, security policy data login information allows a user to access a limited data set of the resource data. Security policy data can relate to a number of different sources but only one user. For example, a user may have resource data access to a number of sources and have the same security policy data login information for each source. Resource data and security policy data can be loaded into the CMDB by a number of communication methods. For example, data can be loaded via a local or remote machine. Further forms of communication are described below.

The resource data and the security policy data are tagged at 106 with an identity of a source of the resource data and the security policy data. A tag is a source identifying data string attached to the resource data and the security policy data. A tag can be, for example, an IP address, a 128-bit string of digits, and/or a source specific identification number, etc. In one or more examples, resource data and security policy data that originate from the same source can have the same tag. That is, the CMDB can relate the resource data and the security policy data because they have the same source identification tag. In an example, tagging the data can include transforming the data via the ETL process to accommodate operational aspects of the CMDB. For example, in addition to tagging the data the ETL process can transform the data so that it is compatible with the CMDB operating system. Operational aspects can include business and technical aspects of the CMDB. For example, business aspects can include, but are not limited to, specific security clearance, read-only restrictions, time sensitive criteria, etc. Technical aspects can include, but are not limited to, translating coded values, encoding free-form values, sorting, transposing, and/or combinations thereof.

A number of data filters are added to the CMDB, at 108. A data filter can exclude certain data according to specified criteria. For example, the number of data filters added to the CMDB can be based on the security policy data. An example of a data filter includes, but is not limited to, permitting a user with a specific security clearance, designated in the security policy data, to access classified data in the CMDB. Data filters can be added to the CMDB based on security policy data including, but not limited to, a username, a password, and combinations thereof, etc. For example, the data filter can require a username and password, based on the security policy data, to access data of a security clearance level in the CMDB. Resource data loaded into the CMDB can, for example, contain data tags indicating a security clearance level of the data, as set forth by security policy. The data filter added to the CMDB can filter out all data with a data tag indicating a security clearance level higher than the security clearance level associated with the username and password entered by the user. Data filters can filter out data, according to security policy data, not associated with a password. For example, a common password can be used for multiple users, where the common password permits access to certain data.

At 110, at least one of the number of data filters is used to filter a user query of the resource data. For example, a user query can include a search of the CMDB for certain data. A data filter based on the security policy of the source of the resource data can filter out resource data that the user is not permitted access to view. An action can be limited with respect to the query according to the security policy data. Actions can include, but are not limited, deny access to data, requesting verification of additional security measures, permitting partial access, etc.

In one or more examples, the resource data and/or the security policy data can be mined from at least one of the number of different sources as part of the ETL process. Mining the resource data and/or the security policy data can also be referred to as extracting the resource data and/or the security policy data. For example, the CMDB, via the ETL process, can extract the number of different sources by searching the number of different sources and loading any new data that is present since the last extraction operation. Extraction can be repeated, for example, at a desired time interval, according to a threshold level of activity on the number of different sources, and/or combinations thereof.

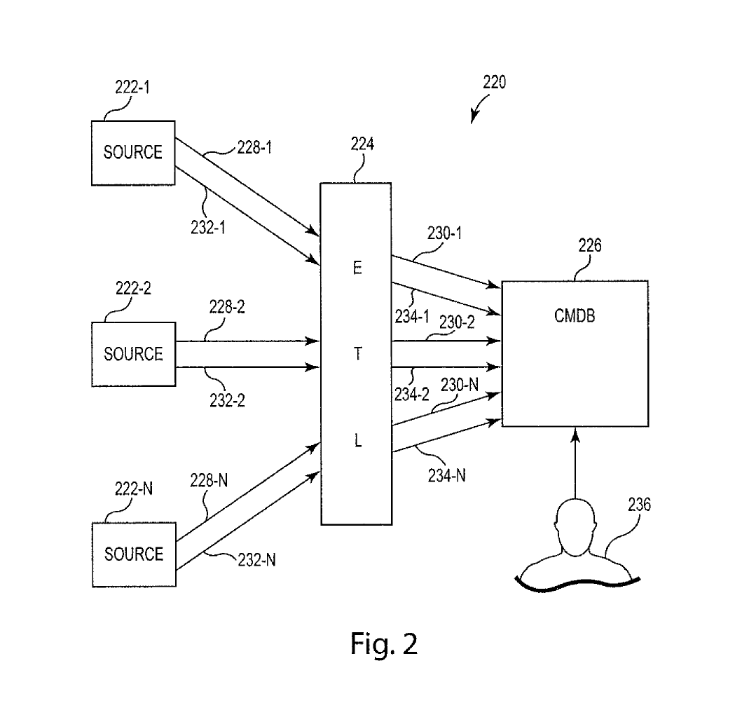

FIG. 2 illustrates a block diagram of an example of an extraction, transformation, load process 220 according to the present disclosure. The process 220 includes a number of sources 222-1, 222-2, . . . , 222-N. However, it will be appreciated that an ETL process according to the present disclosure can include more or fewer sources than 222-1, 222-2, . . . , 222-N. ETL 224 extracts resource data 228-1, 228-2, . . . , 228-N from sources 222-1, 222-2, . . . , 222-N. ETL 224 transforms resource data 228-1, 228-2, . . . , 228-N to accommodate operational needs of CMDB 226. Further, ETL 224 transforms resource data 228-1, 228-2, . . . , 228-N by tagging the resource data with an identity of the source 222-1, 222-2, . . . , 222-N of the resource data. The resulting transformed and tagged resource data 230-1, 230-2, . . . , 230-N is loaded by the ETL process 224 into the CMDB 226. The ETL process additionally extracts security policy data 232-1, 232-2, . . . , 232-N from sources 222-1, 222-2, . . . , 222-N. ETL 224 transforms security policy data 232-1, 232-2, . . . , 232-N to accommodate operational needs of CMDB 226. Further, ETL 224 transforms security policy data 232-1, 232-2, . . . , 232-N by tagging the security policy data with an identity of the source 222-1, 222-2, . . . , 222-N of the security policy data. The resulting transformed and tagged security policy data 234-1, 234-2, . . . , 234-N is loaded into the CMDB 226.

As indicated by process 220, the transformed and tagged data 230-1, 234-1; 230-2, 234-2; and 230-N, 234-N are associated with similar tags because they originate form the same source. When user 236 queries the CMDB 226 for resource data 230-1 the user will have to log-in, for example, according to the associated security policy data 234-1. If the user 236 has the proper log-in credentials to access tagged and transformed resource data 230-1 a data filter, for example, can limit access to specific data of the resource data 230-1 that the security policy log-in information permits.

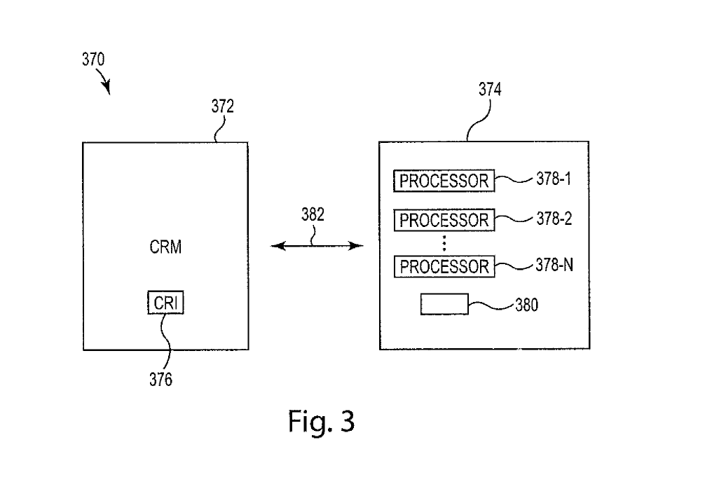

FIG. 3 illustrates a block diagram 370 of an example of a computer-readable medium in communication with processing resources for CMDB security according to the present disclosure. Computer-readable medium (CRM) 372 can be in communication with a computing device 374 having processor resources of more or fewer than 378-1, 378-2, . . . , 378-N, that can be in communication with, and/or receive a tangible non-transitory CRM 372 storing a set of computer-readable instructions 376 executable by one or more of the processor resources (e.g., 378-1, 378-2, . . . , 378-N) for identifying users through a proxy as described herein. The computing device 374 may include memory resources 380, and the processor resources 378-1, 378-2, . . . , 378-N may be coupled to the memory resources 380.

Processor resources can execute computer-readable instructions 376 for CMDB security are stored on an internal or external non-transitory computer-readable medium 372. A non-transitory computer-readable medium (e.g., computer readable medium 372), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), Blu-ray discs (BD), compact discs (CD), and/or a solid state drive (SSD), flash memory, etc., as well as other types of CRM.

The stored instructions may be an installed program or an installation pack. If the stored instructions are an installation pack, the non-transitory computer-readable memory, for example, can be managed by a server such that the installation pack can be downloaded. The non-transitory computer readable medium can also be a portable medium, such as a DVD, CD, flash drive, etc.

The non-transitory computer-readable 372 medium can be integral, or communicatively coupled, to a computing device, in either in a wired or wireless manner. For example, the non-transitory CRM can be an internal memory, a portable memory, a portable disk, or a memory located internal to another computing resource (e.g., enabling the computer-readable instructions to be downloaded over the Internet).

The CRM 372 can be in communication with the processor resources (e.g., 378-1, 378-2, . . . , 378-N) via a communication path 382. The communication path 382 can be local or remote to a machine associated with the processor resources 378-1, 378-2, . . . , 378-N. Examples of a local communication path 382 can include an electronic bus internal to a machine such as a computer where the CRM 372 is one of volatile, non-volatile, fixed, and/or removable storage medium in communication with the processor resources (e.g., 378-1, 378-2, . . . , 378-N) via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 382 can be such that the CRM 372 is remote from the processor resources (e.g., 378-1, 378-2, . . . , 378-N) such as in the example of a network connection between the CRM 372 and the processor resources (e.g., 378-1, 378-2, . . . , 378-N). That is, the communication path 382 can be a network connection. Examples of such a network connection can include a local area network (LAN), a wide area network (WAN), a personal area network (PAN), and the Internet, among others. In such examples, the CRM 372 may be associated with a first computing device and the processor resources (e.g., 378-1, 378-2, . . . , 378-N) may be associated with a second computing device.

Processor resources 378-1, 378-2, . . . , 378-N coupled to the memory 380 can load resource data from a number of different sources into a CMDB via an extract/transform/load (ETL) process. Further, processor resources 378-1, 378-2, . . . , 378-N can load security policy data from the number of different sources into the CMDB via the ETL process. The resource data and/or the security policy data can be mined (e.g., extracted) from the number of different sources via the ETL process. Processor resources 378-1, 378-2, . . . , 378-N can, for example, tag the resource data and the security policy data with an identity of a source of the resource data and an identity of a source of the user security policy data. The processor resources can, for example, further transform the resource data and the security policy data to accommodate business and technical aspects of the CMDB. Processor resources 378-1, 378-2, . . . , 378-N can limit access to the resource data in the CMDB based on the security policy data from the number of different sources. Access to resource data can be limited by data filters based on the security policy data from the source the resource data originated.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The term “a number of” is meant to be understood as including at least one but not limited to one. The phrase “in an example,” as used herein does not necessarily refer to the same example, although it can.

What is claimed:

1. A Configuration Management Database (CMDB) security method, comprising:
loading resource data from a number of different sources into the CMDB;
loading user security policy data from the number of different sources into the CMDB;
tagging the resource data and the user security policy data with an identity of a source of the resource data and an identity of a source of the user security policy data;
adding a number of data filters to the CMDB; and
using at least one of the number of data filters to filter a user query of the resource data.

2. The method of claim 1, comprising limiting an action taken with respect to the query according to the security policy data.

3. The method of claim 1, comprising basing the addition of the number of data filters on the security policy data.

4. The method of claim 1, comprising extracting the resource data and the security policy data from the number of different sources.

5. The method of claim 1, comprising transforming the resource data and the security policy data to accommodate operational needs of the CMDB.

6. The method of claim 1, wherein loading the resource data and loading security policy data including loading the resource data and the security policy data as configuration items.

7. The method of claim 1, comprising mining the resource data and the user security policy data as part of an extract, transform, and load (ETL) process.

8. A non-transitory computer-readable medium including computer-readable instructions stored thereon that, when executed by one or more processors, cause the one or more processors to:
load resource data from a number of different sources into a CMDB;
load user security policy data from the number of different sources into the CMDB;
tag the resource data and the user security policy data with an identity of a source of the resource data and an identity of a source of the user security policy data;
use the security policy data to create a number of data filters in the CMDB; and
use the number of data filters to protect access to the resource data loaded into the CMDB.

9. The non-transitory computer-readable medium of claim 8, comprising instructions that, when executed, cause the one or more processors to mine the resource data and user security policy data from at least one of the number of different sources as part of an Extract/Transform/Load (ETL) process.

10. The non-transitory computer-readable medium of claim 9, wherein the instructions to mine include instructions to load the resource data and the user security policy data via the ETL process.

11. The non-transitory computer-readable medium of claim 9, wherein the instructions to tag include instructions to transform via the ETL process the resource data and the security policy data to accommodate business and technical aspects of the CMDB.

12. The non-transitory computer-readable medium of claim 8, wherein the security policy data relates to login information of a user.

13. A system for identifying users through a proxy, comprising:
a memory operable to store executable instructions; and
a processor coupled to the memory, wherein the processor executes the instructions to:
load resource data from a number of different sources into a CMDB via an extract/transform/load (ETL) process;
load user security policy data from the number of different sources into the CMDB via the ETL process;
tag the resource data and the user security policy data with an identity of a source of the resource data and an identity of a source of the user security policy data; and
limit access to the resource data based on the security policy data from the number of different sources.

14. The system of claim 13, wherein the security policy data relates to login information for a user on more than one system of the number of different sources.

15. The system of claim 14, wherein the security policy data login information allows the user to access a limited data set of the resource data.
